(19) United States
(12) Patent Application Publication
(10) Pub. No.: US 2016/0175794 A1
(43) Pub. Date: Jun. 23, 2016

(54) PROTEIN FOAM

(71) Applicant: QMILCH IP GMBH, Hannover (DE)

(72) Inventor: Anke DOMASKE, Hannover (DE)

(73) Assignee: QMILCH IP GMBH, Hannover (DE)

(21) Appl. No.: 14/907,458

(22) PCT Filed: Jul. 26, 2013
(86) PCT No.: PCT/EP2013/065823

§ 371 Date: Jan. 25, 2016

(51) Int. Cl. B01F 17/00

(52) U.S. Cl. CPC B01F 17/005

(57) ABSTRACT

The invention relates to a method for producing an animal protein- and/or soy protein-containing foam. Since the methods known from the prior art merely use protein as an additive, the invention proposes producing a protein foam in that a homogeneous polymer based on an animal protein and/or soy protein is foamed to form a foam by means of mechanical stress or by the addition of a catalyst or a gas.

### CROSS-REFERENCE TO RELATED APPLICATIONS

This application is a National Stage of International Application No. PCT/EP2013/065823 filed Jul. 26, 2013. The entire disclosure of the above application is incorporated herein by reference.

### BACKGROUND

This section provides background information related to the present disclosure which is not necessarily prior art.

1. Technical Field

The invention relates to a method for producing a foam comprising animal protein and/or soy protein. In addition, the invention likewise relates to a foam which comprises animal protein and/or soy protein, as well as a composition for producing such a foam.

Foams which comprise animal protein and/or soy protein, as well as processes for their production, are already known in the prior art. The known foams include a main component from natural raw materials, such as, for example, ash, and protein as binder. Since these products have at least partially renewable raw materials which are biodegradable and/or compostable, a contribution to sustainability and environmental compatibility is achieved. Consequently, an improvement compared to the foams made of, for example, polyurethane likewise known in the prior art has already been provided, the advantages being evident particularly in the reduction in complex recycling processes, which entail not inconsiderable environmental problems. By using animal proteins and/or soy proteins as additive, moreover, a foam was provided which is available in a durable and sustainable manner at least to a certain degree. Efforts have thus already been introduced on the part of industry to replace crude-oil-linked raw materials and foams and/or molded parts produced therefrom.

2. Discussion

For example, the document WO 2011/006660 A1 discloses a method and a molding compound for producing a molded part, such as e.g. an automobile component, a cladding section, an insulating material or the like, which has a biodegradable binder and a filler. The binder consists of a mixture of milk protein and lime. The filler includes, for example, blowing agents, granules, fiber materials or the like.

The document EP 0 417 582 A2 discloses a method for producing an open-pore foam from a molding compound which consists of an inorganic stone-forming component such as e.g. ash, a water-containing second component, which brings about the curing reaction, and a foam-forming component. Additionally, this molding compound has a plant or animal protein which is used as “pore opener” that interrupts the wall formation of the foam pores during the foaming and curing reaction.

Although the aforementioned foams already have raw materials which are renewable and biodegradable, these nevertheless require the addition of a large amount of further components such as, for example, a stone-forming component or a filler. Since the proteins are merely used as additive such as binder or “pore opener”, these have a negligibly small fraction in the subsequent molded part or the molding compound. The further substances used which form the main constituent of the molded part in the prior art cannot be directly degraded, but likewise have to be subjected to material separation or prolonged storage until complete biodegradation.

### SUMMARY OF THE INVENTION

It is therefore an object of the present invention to provide a method for producing a protein foam or such a protein foam and a composition for its production which use biodegradable substances and in particular require no further filling materials or stone-forming components.

To achieve this object, the invention provides a method for producing a protein foam in which a homogeneous polymer based on animal protein and/or soy protein is foamed under mechanical stress or with the addition of a catalyst or gas to give a foam. Consequently, a foam can now be provided for the first time which is based on animal protein and/or soy protein and thus advantageously consists entirely of renewable and biodegradable raw materials. As a result of the foaming under mechanical stress, a dimensionally stable, elastic foam is formed which renders the addition of a filler or of a stone-forming component superfluous. This is attributed to stabilizing structural changes during the mechanical stress. The animal protein and/or soy protein can even be the main component of the foam.

It is known that animal protein (milk protein) or else soy protein has foam-forming properties. Particularly in the field of the food and cosmetics industries, the foam-forming properties of proteins, in particular of casein, are already used. The invention proceeds from this finding and uses the foam-forming properties also for producing a foam which can be further processed for example to give packaging material.

The processing time and the use of chemicals are reduced with the invention. The foams consist for the most part of biodegradable raw materials and permit the recycling of the foam products produced therefrom. At the same time, the consumption of water and energy is reduced and the productivity increased.

The present invention is directed to foams which are produced by a continuous or discontinuous process and which have destructured proteins as biodegradable thermoplastic polymers. In this connection, at least one protein obtained from milk or a protein produced by bacteria is plasticized, optionally together with a plasticizing agent at temperatures between room temperature and 140° C. under mechanical stress.

The invention is based on the finding that the proteins, in particular casein and derivatives thereof, can be plasticized and polymerized in this way. It is preferably provided that the plasticization takes place at temperatures up to 140° C.

For an even gentler treatment, the protein is intensively mixed or kneaded together with a plasticizing agent and in so doing is mechanically stressed. The required plasticizing temperature is significantly reduced by virtue of the plasticizing agent.

The protein is preferably casein, lactalbumin or soy protein.

The protein obtained from milk can be produced by precipitation from milk in situ. For this, according to a first procedure, the milk can be introduced into the process in a mixture with rennet, other suitable enzymes or acid directly as a coagulated mixture. Alternatively, the squeezed, coagulated protein can be used wet. According to another possible procedure, a pure or mixed protein obtained, if necessary prepared, separately beforehand, i.e. a protein fraction from milk, can be used, e.g. dried as powder.

The protein fraction can also be produced by a gas treatment, by ultrafiltration or by cell cultures. Moreover, proteins can, for example, be modified with additional salts such as sodium and potassium in further processing steps such that a casein is formed.

The animal protein can be in particular casein or lactalbumin which has been obtained from goats' milk, sheep's milk or cows' milk.

The milk protein used according to the invention can be mixed with other proteins in a fraction up to 70% by weight, based on the milk protein. Contemplated for this purpose are, for example, other albumins, such as ovalbumin and plant proteins, in particular lupine protein, soy protein or wheat proteins, in particular gluten.

A mixture of solvent and protein is generally mixed under pressurized conditions and with shearing in order to increase the rate of the crosslinking process. Chemical or enzymatic agents can likewise be used in order to destruct and to crosslink, to oxidize or to derivatize, etherify, saponify and esterify the proteins. Usually, proteins are destructed by dissolving the proteins in water. Completely destructed proteins are formed if no clumps are present which influence the polymerization.

A plasticizing agent can be used so that the foam does not lose brittleness. Similarly, plasticizing agents can be used in order to increase the melt processability. A plurality of different plasticizing agents can be used simultaneously. The plasticizing agents can also improve the flexibility of the end products. The plasticizing agents are essentially compatible with the polymeric constituents of the present invention, meaning that they can effectively modify the properties of the composition. As used herein, the expression “essentially compatible” means that the plasticizing agent is able, upon heating to a temperature above the softening and/or the melting temperature of the composition, to form an essentially homogeneous mixture with proteins.

Besides water as plasticizing agent, other plasticizing agents, in particular alcohols, polyalcohols, carbohydrates in aqueous solution and in particular aqueous polysaccharide solutions, can be used.

Specifically, the following plasticizing agents are preferred: hydrogen-bridge-forming organic compounds without hydroxyl group, e.g. urea and derivatives; animal proteins, e.g. gelatin; plant proteins, such as e.g. cotton; soybean and sunflower proteins; esters of evolving acids which are biodegradable, e.g. citric acid, adipic acid, stearic acid, oleic acid; hydrocarbon-based acids, e.g. ethylene acrylic acid, ethylene maleic acid, butadiene acrylic acid, butadiene maleic acid, propylene acrylic acid, propylene maleic acid; sugars, e.g. maltose, lactose, sucrose, fructose, maltodextrose, glycerol, pentaerythritol and sugar alcohols, e.g. malitol, mannitol, sorbitol, xylitol; polyols, e.g. hexanetriol, glycols and the like, also mixtures and polymers; sugar anhydrides, e.g. sorbitan; esters, such as e.g. glycerol acetate, (mono-, di-, triacetate) dimethyl and diethyl succinate and related esters, glycerol propionates, (mono-, di-, tripropionates) butanoates, stearates, phthalate esters. Further influential factors are the affinity to the proteins, amount of protein and molecular weight. Glycerol and sugar alcohols are some of the most important plasticizing agents. Weight fractions of plasticizing agents are e.g. 5%-55%, but can also fluctuate in the range from 2%-75%, based on the milk protein. Any desired alcohols, polyols, esters and polyesters can be used in weight fractions preferably up to 30% in the polymer mixture.

Besides the proteins, further foaming agents can aid the foam formation. Thus, for example, a lime and/or a lime substitute from the group NaOH, KOH solution, sodium hydrogencarbonate, ammonium hydrogencarbonate, potash and/or wood ash and/or carbonates can be admixed with the protein.

Blowing agents and/or raising agents can be added to the protein mixture which either assist or trigger the foaming.

All commercially available blowing agents such as carbon dioxide with or without alcohol, nitrogen, butane, pentane or chemical blowing agents such as sodium carbonate, potassium carbonate or reaction products of citric acid are contemplated.

Moreover, alcohols such as, inter alia, ethanol can assist the foam formation and be used as auxiliaries.

Further foaming agents are known from the prior art. On the one hand, it is possible to use peroxides, preferably hydrogen peroxide in aqueous solution, and/or sodium perborate. Moreover, a metal powder such as, for example, aluminum, can be added to the milk protein mixture.

A catalyst is sometimes required for the chemical foaming reaction. This may be present, inter alia, in the form of acids, for example tartaric acid, salts, for example hartshorn salt, or lime or carbonates. The reaction accelerators make it possible to foam the foams in a short time.

Preference is given to exothermic reactions.

A curing agent of alkali silicates can additionally be added to the protein mixture, for example, and without limitation inter alia waterglass or silica can be used.

Moreover, binders, such as, for example, cement, can also be added to the milk protein mixture.

The processability of the protein mass can be modified by further materials in order to influence the physical and mechanical properties of the protein mass, but also those of the end product. Nonlimiting examples include thermoplastic polymers, crystallization accelerators or inhibitors, odor masking agents, crosslinking agents, emulsifiers, salts, glidants, surfactants, cyclodextrins, lubricants, other optical brighteners, antioxidants, processing auxiliaries, fire retardants, dyes, pigments, fillers, proteins and their alkali metal salts, waxes, adhesive resins, extenders and mixtures thereof. These auxiliaries are bonded to the protein matrix and influence it in its properties.

Inorganic fillers are likewise possible additives and can be used as processing agents. Possible examples are oxides, silicates, carbonates, lime, clay, limestone and kieselguhr and inorganic salts. Stearate-based salts and colophony can be used for modifying the protein mixture. An addition of fiber substances as reinforcement is likewise possible.

Further additives are enzymes, surfactants, acids, serpins, phenolic plant molecules and secondary plant substances which can contribute as crosslinkers, foaming agents and for improving the mechanical properties, as well as for resistance in water and proteases.

Other additives may be desirable depending on the particular end use of the envisaged product. For example, in most products, wet strength is a required property. It is therefore necessary to add wet-strength resins and sizes as crosslinking agents.

Further natural polymers can also be added as additives. Possible examples of natural polymers, without limiting the selection, would be albumins, soy protein, zein protein, chitosan and cellulose, polylactide and “PLA”, which can be used in an amount of 0.1%-80%.

Both carbohydrates and polysaccharides, as well as amyloses, oligosaccharides and chenodeoxycholic acids can be used as further auxiliaries and additives.

Furthermore, carboxylic acids, dicarboxylic acids and carbonates, as well as the salts and esters thereof, and also fatty acids can be added.

It is likewise provided that the foam is varied by adding or aftertreating with surfactants, acids, serpins, and phenolic molecules and/or polysaccharides from plants or plant secondary substances with regard to its mechanical properties.

Depending on the raw material feed, an open-pore or a fine-pore foam can be produced. The pore size and the degree of open-pore nature can be adjusted. It is likewise possible to produce a flexible foam or a rigid foam.

Besides the chemical foaming, the protein mixture can also be foamed as a result of physical blowing agents, which are often present in the gaseous state. Solid, gaseous or liquid blowing agents such as carbon dioxide, nitrogen, air, noble gases such as, for example, helium or argon, aliphatic hydrocarbons such as propane, butane, partially or completely halogenated aliphatic hydrocarbons, such as fluoro (hydro)carbons, fluorochloro(hydro)carbons, difluoroethane, aliphatic alcohols or dinitrogen oxide (laughing gas) are suitable as blowing agents. Carbon dioxide, laughing gas and/or nitrogen are preferred. Carbon dioxide is very particularly preferred.

The resulting foam and the products produced therefrom can be used for all conceivable purposes. Nonlimiting examples include: all types of components for automobile and aircraft assembly, the construction industry, building material and light building boards, antislip coatings, composite materials, insulation layers or filler layers, also for multilayered moldings, the furniture industry, the electronics industry, sports equipment, toys, mechanical and chemical engineering, the packaging industry, agriculture or safety technology, paper, adhesives, medical technology, life science, household articles.

For this, the foam can be present and further processed as granules, composite material, in particular fiber composite material, nanoparticles, nanofibers, matrix systems or the like.

Depending on the field of application, it is necessary that the materials are as light as possible and at the same time dimensionally stable.

The advantages attained with the invention consist, inter alia, in the fact that the reduction of substances that are harmful to health and the environment during the process and in the foams themselves is made possible. Moreover, the foam is biodegradable.

Moreover, considerable resources of energy, water, time and manpower can be saved, which increases environmental protection and improves economic feasibility. The particularly advantageous properties of the milk protein plastics are attributed to stabilizing structural changes.

The foams are preferably produced using an extrusion or mixer process in order to permit the highest possible productivity. All production processes for plastics or foams known to the person skilled in the art can be used without exception. What is essential to the invention is the production of a homogeneous polymer, preferably of a biogenic biopolymer, which is biodegradable and compostable. The foam mass is produced by the continuous or discontinuous process known from the literature and to the person skilled in the art, preferably by mixing or extruding a premix with the addition of additives or the mixing of the polymer mass with the metered addition of the basic materials and additives during the mixing or extruding.

The plastics can be produced by processes known to the person skilled in the art, e.g. by injection molding, mixing or extrusion processes.

The process offers the advantage and the option to influence the properties of the protein foams by changing the addition of raw materials according to the requirements of the intended use.

The thus obtained mixture of the components is then extruded through a nozzle, typically producing a semi-finished product (foil, film, hose, tube, etc.), which has a foam structure as a result of the spontaneous expansion of the pressurized blowing agent. Depending on the nozzle geometry, foam structures and polymer foams with different shapes can likewise be produced.

Following the formation of the foam, the foam can be further treated or the bonded substance is treated. In a further development of the invention, the polymer mass can moreover pass through a bath prior to curing, although this procedure is generally not required. Alternatively, after exiting from the nozzle, the polymer mass can be subjected to a spray treatment or alternatively to a gas treatment, an ice treatment, a drying and blowing treatment, an ion treatment, a UV treatment or an enzyme treatment, and also to a renaturation by salts or esterification, etherification, saponification or a further crosslinking, granulation, etc.

### EXAMPLES

The invention is described in more detail below by reference to a working example. The working example serves merely for illustrative purposes and is not intended to limit the invention. The person skilled in the art can discover further working options by reference to this working example and with the help of his expertise by varying the parameters.

### Example 1

Preparation of a milk protein foam mass. The extrusion is performed with a twin-screw extruder model 30 E from Dr. Collin with a diameter of 30 mm. The foam is produced by means of extrusion technology.

The heating takes place via 4 cylinder heating zones with the following temperature course: 65° C., 74° C., 75° C., 60° C.:

| Temperature | 65 | 74 | 74 | 74 | 75 | 60 |
|---|---|---|---|---|---|---|
| Function | Material | Water | Plasticizing | Ejection | Head | Nozzle |
| | feed | feed | zone | zone | | |
| Heating | I | II | II | II | III | IV |
| zone | | | | | | |

Casein powder is added via a vibrating chute. The addition of water takes place via a hose pump. The additives and auxiliaries are added by means of further metering devices. The polymer mass is processed via an extrusion process to give a foam in which one of the metering devices feeds a foaming agent into the extrusion process.

### Example 2

Producing a milk protein composition. The extrusion takes place with a twin-screw extruder model 30 E from Dr. Collin with a diameter of 30 mm. Merely a premix is produced by means of the extruder.

The casein powder is added via a vibrating chute. A liquid medium is added via a hose pump. The additives and auxiliaries are added via further metering devices.

The polymer mass is processed in a batch process to give a foam, with the polymer mass then being placed into a mixer and a catalyst and/or foaming agent being added.

Example 3

Producing a milk protein foam mass. The extrusion takes place with a twin-screw extruder model 30 E from Dr. Collin with a diameter of 30 mm. A premix is produced by means of extrusion technology.

The casein power is added via a vibrating chute. A liquid medium is added via a hose pump. The additives and auxiliaries are added via further metering devices.

The polymer mass is foamed by the feeding in of CO₂ during the extrusion process and molded to give a molding after exiting from the nozzle.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method for producing a foam comprising animal protein and/or soy protein, wherein a plasticized polymer mass, at least consisting of a homogeneous polymer based on animal protein and/or soy protein is foamed under mechanical stress or with the addition of a catalyst or gas to give a foam.

2. The method as claimed in claim 1, wherein the homogeneous polymer is processed by means of an extruder or mixer.

3. The method as claimed in claim 1, wherein at least one animal protein and/or soy protein is plasticized together with a plasticizing agent, in particular water, alcohol, polyalcohol, aqueous carbohydrate solution and/or aqueous polysaccharide solution.

4. The method as claimed in claim 1, wherein the plasticization takes place at temperatures below 140° C.

5. The method as claimed in claim 1, wherein lime and/or lime substitute, in particular from the group NaOH solution, KOH solution, sodium hydrogencarbonate, ammonium hydrogencarbonate, potash, wood ash, carbonates, peroxides, raising agents, sodium perborate, is used for the foaming.

6. The method as claimed in claim 1, wherein the foaming includes a physical foaming in particular by means of carbon dioxide, nitrogen, air, noble gas, hydrocarbons, difluoroethane, alcohol and/or dinitrogen oxide.

7. The method as claimed in claim 1, wherein additives and auxiliaries are added to the proteins, by admixing before or during foaming, selected from the group: water, aqueous carbohydrate solution, aqueous polysaccharide solution, oligosaccharides, alcohol, polyalcohol, fats, acids, amino acid, peptides, salts, cations, enzymes and/or mixtures of these.

8. The method as claimed in claim 1, wherein a binder, in particular cement, is added to the proteins.

9. The method as claimed in claim 1, wherein resin is added to the milk protein mixture.

10. A foam comprising animal protein and/or soy protein, produced by a method as claimed in claim 1, wherein the foam has a foamed homogeneous polymer based on animal protein and/or soy protein.

11. The foam as claimed in claim 10, further comprising a density of 30 kg/m³.

12. A composition for producing a foam as claimed in claim 10, wherein the composition has a homogeneous polymer based on animal protein and/or soy protein.

13. The composition as claimed in claim 12, further comprising a plasticizing agent, in particular water, alcohol, polyalcohol, aqueous carbohydrate solution and/or aqueous polysaccharide solution.

14. The composition as claimed in claim 12, further comprising a foaming agent, in particular lime and/or lime substitute.

15. The composition as claimed in claim 12, further comprising additives and auxiliaries, in particular from the group: water, aqueous carbohydrate solution, aqueous polysaccharide solution, oligosaccharides, alcohol, polyalcohol, fats, acids, amino acid, peptides, salts, cations, enzymes and/or mixtures of these additives and auxiliaries. Abstract:
